(19) United States
(12) Patent Application Publication
(10) Pub. No.: US 2008/0116281 A1
(43) Pub. Date: May 22, 2008

(54) Automatic triggering in MEMS-based electro-optical reader and method

(76) Inventor: Edward Barkan, Miller Place, NY (US)

Correspondence Address: KIRSCHSTEIN, OTTINGER, ISRAEL;& SCHIFFMILLER, P.C., 489 FIFTH AVENUE, NEW YORK, NY, 10017, US

(21) Appl. No.: 11/586,246

(22) Filed: Oct. 25, 2006

(51) Int. Cl. G06K 7/10

(52) U.S. Cl. 235/472.01

(57) ABSTRACT

A housing for supporting a scan engine having an oscillatable microelectromechanical systems (MEMS) scan component is supported by an operator in a hand-held mode of operation, and is supported by a support in a hands-free mode of operation. A control detects when the housing is supported by the support, and automatically actuates the scan engine upon such detection.

### BACKGROUND OF THE INVENTION

Various electro-optical readers have previously been developed for reading bar code symbols appearing on a label, or on a surface of a target. The bar code symbol itself is a coded pattern of indicia, such as bars and spaces. Generally, the readers electro-optically transform graphic indicia of the symbols into electrical signals, which are decoded into alphanumeric characters. The resulting characters describe the target and/or some characteristic of the target with which the symbol is associated. Such characters typically comprise input data to a data processing system for applications in point-of-sale processing, inventory control, article tracking and the like.

Moving beam electro-optical readers have been disclosed, for example, in U.S. Pat. No. 4,251,798; No. 4,369,361; No. 4,387,297; No. 4,409,470; No. 4,760,248; and No. 4,896,026, and generally include a light source consisting of a gas laser or semiconductor laser for emitting a laser beam. The laser beam is optically modified, typically by a focusing optical assembly, to form a beam spot at a predetermined target location. The laser beam is directed by a scanning component along an outgoing optical path toward a target symbol for reflection therefrom. The reader operates by repetitively scanning the laser beam in a scan pattern, for example, a line or a series of lines across the target symbol by movement of the scanning component, such as a scan mirror, disposed in the path of the laser beam. The scanning component may sweep the beam spot across the symbol, trace a scan line across and beyond the boundaries of the symbol, and/or scan a predetermined field of view.

Moving beam readers also include a photodetector, which functions to detect laser light reflected or scattered from the symbol. In some systems, the photodetector is positioned in the reader in a return path so that it has a field of view, which extends at least across and slightly beyond the boundaries of the symbol. A portion of the laser beam reflected from the symbol is detected and converted into an analog electrical signal. A digitizer digitizes the analog signal. The digitized signal from the digitizer is then decoded by a decoder, based upon the specific symbology used for the symbol, into a binary data representation of the data encoded in the symbol. The binary data may then be subsequently converted into the alphanumeric characters represented by the symbol.

Depending upon the application, such moving beam readers can be configured in housings of various configurations, such as a gun-shaped housing typically held in the palm of an operator's hand in a hand-held mode of operation, or placed on a countertop or in an equipment stand in a hands-free mode of operation, or a box-shaped housing that rests on a countertop to read symbols in a hands-free mode, and is lifted off the countertop and aimed at the symbols to read them in a hand-held mode, or a housing of arbitrary shape that is fixedly mounted at a workstation in which the symbols are read.

It is known, for example, in U.S. Pat. No. 6,155,490; No. 6,616,046; and No. 7,007,843 to use microelectromechanical systems (MEMS) technology in moving beam readers to eliminate macroscopic mechanical and electronic components and to replace them with miniature scan elements or mirrors to sweep the laser beam across the indicia to be electro-optically read. These MEMS-based systems are generally fabricated using integrated circuit fabrication techniques or similar techniques such as surface micromachining or bulk micromachining. A common material used is polycrystalline silicon (polysilicon). These MEMS-based systems are small in size and have low power consumption.

As advantageous as these MEMS-based readers are, experience has shown that they are unsatisfactory in some respects. For example, when physical triggers are used on such MEMS-based readers, the triggers are prone to breakage, especially after repeated, prolonged use. It is necessary to manually actuate the trigger to read each symbol in its turn, a laborious exercise especially if many symbols are to be read. In the event of a fixed reader, the trigger may be located in a region not readily accessible to the operator. The art has proposed so-called triggerless readers for non-MEMS-based readers that have no trigger to break, but these readers are energized all the time, thereby consuming electrical energy, generating waste heat, and shortening the working lifetime of such components as the laser light source and the drive for the scan element. Energy consumption is a problem for battery-operated readers, and especially for small form factor readers since a smaller reader has a smaller, lighter battery that has a correspondingly smaller energy capacity.

### SUMMARY OF THE INVENTION

One feature of this invention resides, briefly stated, in a reader for, and a method of, electro-optically reading indicia such as bar code symbols located in a range of working distances from the reader, the symbols having bars and spaces of different light reflectivity. The symbols may be printed or otherwise borne on targets. The reader includes a housing in which an actuatable scan engine is mounted.

The scan engine includes a light source, preferably a laser, for generating a laser beam, a focusing lens for modifying the laser beam to have a beam spot in cross-section at a beam waist located within the range of working distances, an oscillatable microelectromechanical systems (MEMS) scan mirror, a drive for oscillating the MEMS mirror for scanning the laser beam spot in scans over the symbols for reflection as light of variable intensity therefrom, a photodetector for detecting the reflected light of variable intensity and for generating electrical analog signals indicative of the variable intensity light, and signal processing circuitry including a digitizer for digitizing the analog signals into digitized signals and a decoder, preferably a programmed microprocessor, for decoding the digitized signals into data corresponding to the symbols.

In accordance with one feature of this invention, the housing is supported by an operator in a hand-held mode of operation, and is supported by a support in a hands-free mode of operation. A control is operative for detecting when the housing is supported by the support, and for automatically actuating the scan engine upon such detection.

In one preferred embodiment, the housing has a handle gripped by the operator's hand in the hand-held mode of operation, and the support may be a base on the housing, or a stand for supporting the housing above a generally planar support surface. The control preferably includes a control element in the stand and another control element in the housing for detecting the presence and absence of the housing on the stand. The control elements may be magnetic or optical sensors in the stand and the housing, or at least one mechanical switch in the stand and the housing.

In another preferred embodiment, the control includes a configurable controller, e.g., the microprocessor, in the scan engine, and the controller is configured by a remote host to automatically actuate the scan engine. Alternatively, the controller may be configured by having the reader read a special configuration symbol to automatically actuate the scan engine.

To save energy, the control is operative for cyclically deactuating the scan engine after automatic actuation of the scan engine. For example, the laser and/or the MEMS drive can be turned off for a percentage of the scans. This percentage can be increased as the time increases since the last symbol has been read. By way of a numerical example, the laser may initially operate at a 100% duty cycle for five minutes after a symbol has been successfully read, and be changed to a 50% duty cycle by having the control turn the laser on every other scan after fifteen minutes of non-use, and be changed to a 10% duty cycle by having the control turn the laser on every tenth scan after thirty minutes of non-use, and be turned off completely after sixty minutes of non-use. The MEMS mirror oscillates at relatively high speeds, such as five hundred scan per second, and, hence, even a 10% duty cycle will produce a relatively responsive reader since the laser will be turned on for fifty scans per second.

Another way to save energy is to have the control cyclically deactuate the scan engine at opposite ends of each scan line after automatic actuation. For example, the laser is turned off at the ends of each scan line, thereby consuming less energy. This also makes the scan line shorter and brighter, even as the duty cycle decreases.

If the scan engine has been turned completely off after a prolonged period of non-use, then it may be awakened by pressing a trigger, or by removing the housing from the stand and by replacing it thereon, or by a command signal from a host. Alternatively, an object sensor such as an optical sensor may be mounted on the housing and is operative to wake up the scan engine when the sensor senses that an object has been placed in its field of view.

Hence, according to one feature of this invention, the reader does not utilize a physical trigger subject to breakage as in the prior art to initiate reading when the reader is mounted in a hands-free mode on a generally planar support surface, or a stand, or a fixed support. Also, the reader in the hands-free mode is not energized all the time, thereby saving electrical energy, reducing the generation of waste heat, increasing the lifetime of the scan engine, especially the laser and the drive, as well as increasing the working lifetime of an on-board battery in the case of a wireless reader to power the reader.

The novel features which are considered as characteristic of the invention are set forth in particular in the appended claims. The invention itself, however, both as to its construction and its method of operation, together with additional objects and advantages thereof, will be best understood from the following description of specific embodiments when read in connection with the accompanying drawings.

### BRIEF DESCRIPTION OF THE DRAWINGS

FIG. 1 is a schematic diagram of a hand-held, non-MEMS-based, retro-collective reader for reading bar code symbols in accordance with the prior art;

FIG. 2 is a schematic diagram of a hand-held, MEMS-based, non-retro-collective reader for reading bar code symbols in accordance with the invention;

FIG. 3 is a perspective view of a portable electro-optical reader operative in either a hand-held mode, or in the illustrated workstation mode, for reading bar code symbols in accordance with this invention;

FIG. 4 is a perspective view of another portable electro-optical reader operative in either a hand-held mode, or in the illustrated workstation mode, for reading bar code symbols in accordance with this invention;

FIG. 5A is a perspective view of still another embodiment of a portable electro-optical reader operative in a hands-free workstation mode in accordance with this invention;

FIG. 5B is a perspective view of the embodiment of FIG. 5A in a hand-held mode in accordance with this invention; and

FIG. 6 is a broken-away view of a detail of the embodiment of FIG. 5A.

### DETAILED DESCRIPTION OF THE PREFERRED EMBODIMENTS

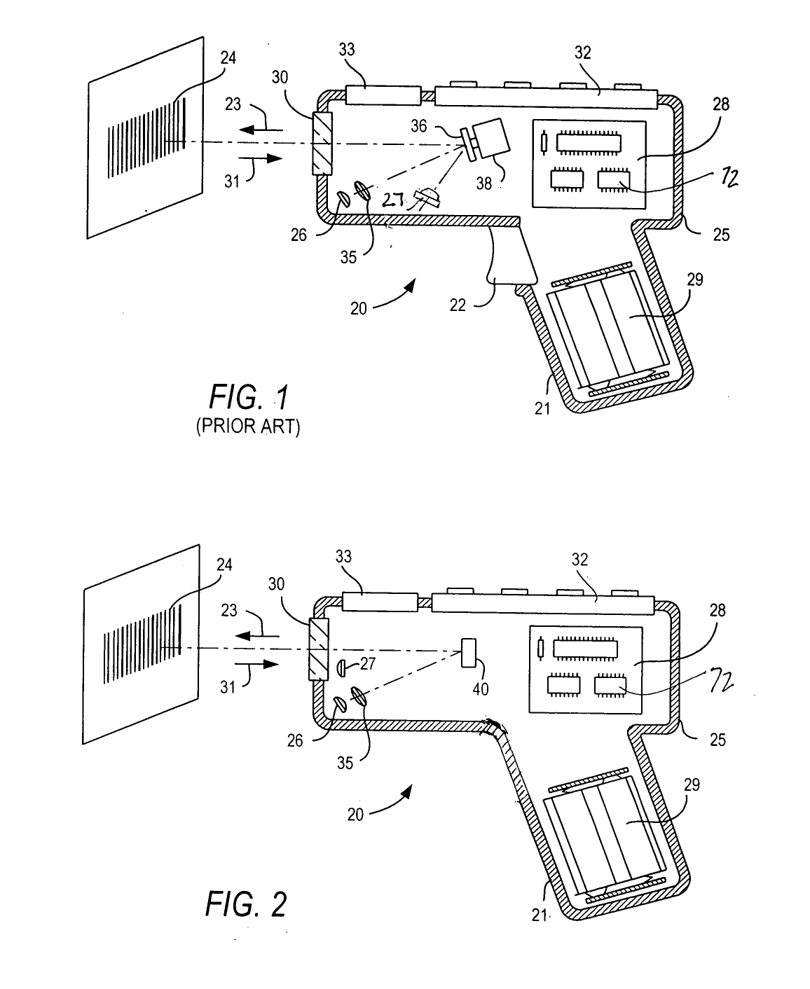

Reference numeral 20 in FIG. 1 generally identifies a hand-held, non-MEMS-based, retro-collective reader for electro-optically reading indicia, such as a bar code symbol 24, located in a range of working distances therefrom. The reader 20 has a housing 25 with a pistol grip handle 21 and a manually actuatable trigger 22, which, when depressed, actuates a scan engine and enables a light beam 23 to be directed at the symbol 24. The scan engine in the housing 25 includes a light source 26, preferably a laser diode for emitting a laser beam, a light detector 27, and signal processing circuitry 28 including a controller 72. A battery pack 29 is accommodated in the handle 21. A light-transmissive window 30 at a front of the housing enables the light beam 23 to exit the housing, and allows light 31 of variable intensity scattered off the symbol to enter the housing. A keyboard 32 and a display 33 may advantageously be provided on a top wall of the housing for ready access thereto.

In use, an operator holding the handle 21 aims the housing in a hand-held mode at the symbol and depresses the trigger 22. The light source 26 emits the light beam 23, which is optically modified and focused by focusing optics 35 to form a beam spot in cross-section on the symbol 24. The beam travels to a scan mirror 36 which is repetitively oscillated at a scan rate of at least 20 scans a second by a motor drive 38. The scan mirror 36 reflects the beam spot incident thereon along an outgoing optical path to the symbol 24 for reflection therefrom and sweeps the beam spot across the symbol in a scan pattern. The scan pattern can be a line extending lengthwise along the symbol along a scan direction, or a series of lines arranged along mutually orthogonal directions, or an omnidirectional pattern, just to name a few possibilities.

The reflected light 31 has a variable intensity over the scan pattern and passes through the window 30 along a return path coincident with the outgoing path onto the scan mirror 36 where it is reflected to the photodetector 27 for conversion to an analog electrical signal. The signal processing circuitry 28 includes a digitizer operating under the control of the controller 72 or microprocessor, the controller being operative to decode and process the signal and extract the data encoded in the symbol.

FIG. 2 is identical to FIG. 1, except in the following respects. A microelectromechanical systems (MEMS) component 40 is positioned in the outgoing path of the light beam and replaces the larger scan mirror 36 and the motor drive circuit 38. The component 40 has an outer reflecting surface and, hence, serves as a scan mirror for reflecting the incident light beam focused by the focusing optics 35 toward the symbol 24. Due to the miniature size of the MEMS mirror 40, it cannot reliably serve as a collector and, hence, the photodetector 27 is moved to face the window 30 and, in effect, “stare” at the symbol. FIG. 2 generally illustrates a hand-held, MEMS-based, non-retro-collective reader. Also, as explained below, the physical trigger 22 has been eliminated.

The MEMS mirror 40 can be made to resonate at a desired frequency, either in one direction or in two directions. The resonant frequency may be induced electronically or mechanically. The MEMS mirror 40 preferably has a polished or highly reflective surface such as a silvered surface. The mirrored surface may be a 1.5 mm diameter silvered circular surface and an applied drive voltage may be in the 12 volt range that would result in oscillations of approximately 500 Hz by 10 Hz.

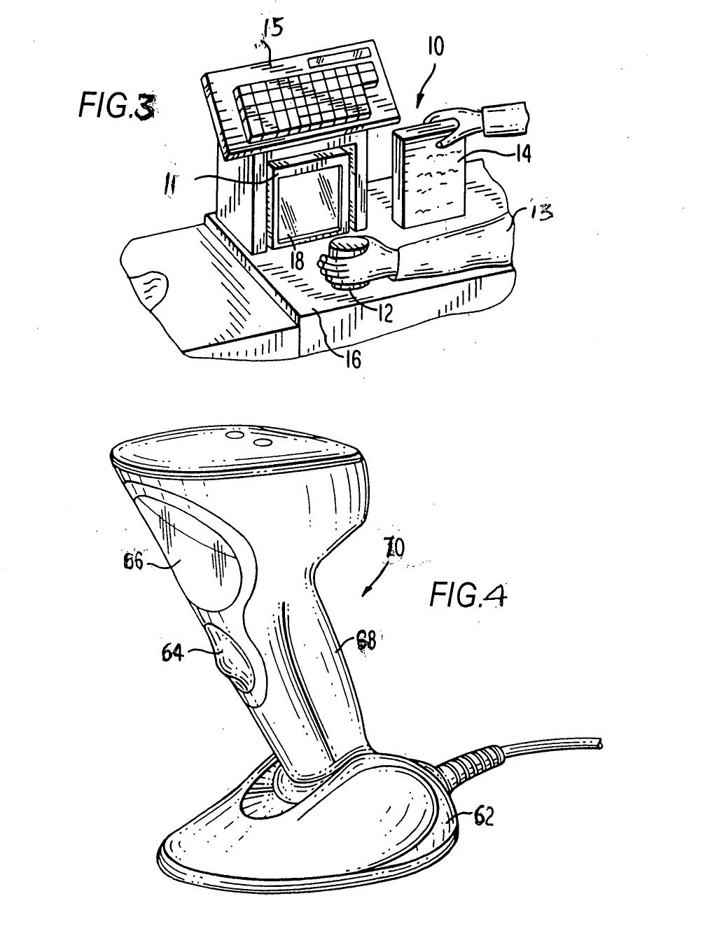

Reference numeral 10 in FIG. 3 generally identifies a workstation at which an electro-optical reader 11 in a hands-free workstation mode processes transactions. The MEMS-based scan engine of FIG. 2 is mounted in the reader 11. The reader 11 is mounted on a checkout counter at a retail site at which products, such as a can 12 or a box 14, each bearing a target symbol, are processed for purchase. The counter includes a countertop 16 across which the products are slid at a swipe speed past a generally vertical window 18 of a box-shaped vertical slot reader 11 mounted on the countertop 16. A checkout clerk or operator 13 is located at one side of the countertop, and the reader 11 is located at the opposite side. A cash/credit register 15 is located within easy reach of the operator. The reader 11 is portable and lightweight and may be picked up from the countertop 16 by the operator 22 in a hand-held mode, and the window 18 may be aimed at a symbol preferably on a product too heavy or too large to be easily positioned on the countertop in front of the reader in the workstation mode.

Reference numeral 70 in FIG. 4 generally identifies another portable, electro-optical reader having a different configuration from that of reader 11. The MEMS-based scan engine of FIG. 2 is mounted in the reader 70. Reader 70 has a generally vertical window 66 and a gun-shaped housing 68 supported by a base 62 for directly supporting the reader 70 on a countertop. The reader 70 can thus be used as a stationary hands-free workstation in which products are slid or swiped past the generally vertical window 66, or can be picked up off the countertop and held in the operator's hand and used as a hand-held reader in which a trigger 64 is manually depressed to initiate reading of the symbol.

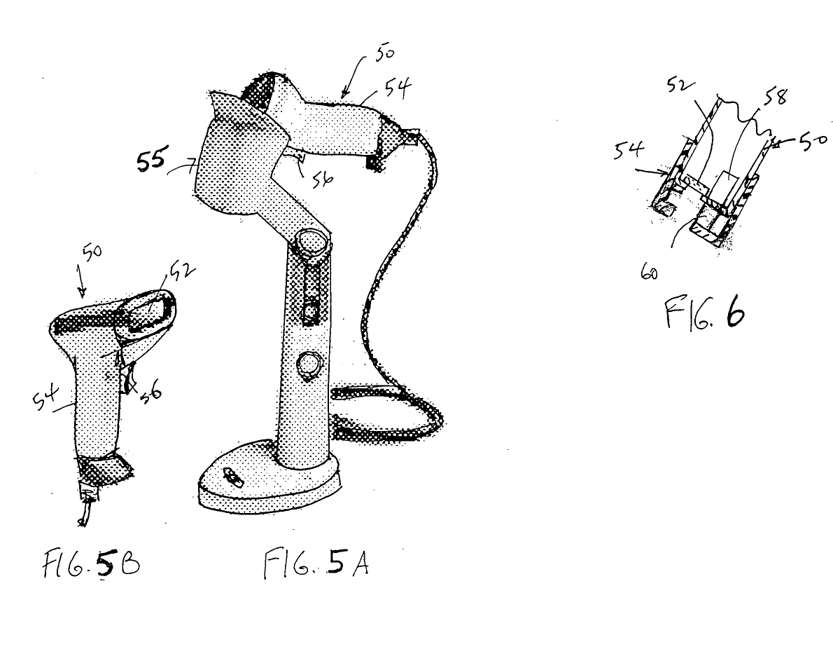

Reference numeral 50 in FIGS. 5A, 5B generally identifies another portable, electro-optical reader having yet another operational configuration. The MEMS-based scan engine of FIG. 2 is mounted in the reader 50. Reader 50 has a generally vertical window 52 and a gun-shaped housing 54 and is supported in a hands-free workstation mode (FIG. 5A) by a stand 55 on a countertop. The reader 50 can thus be used as a stationary workstation in which products are slid or swiped past the generally vertical window 26, or can be picked up off the countertop and held in the operator's hand in a hand-held mode (FIG. 5B) and used as a hand-held reader in which a trigger 56 is manually depressed to initiate reading of the symbol.

In accordance with one feature of this invention, the housing of each reader 11, 50, 70 is supported by a human operator in a hand-held mode of operation, and is supported by a non-human support in a hands-free mode of operation. A control 58, 60 (FIG. 6) is operative for detecting when the housing of each reader 11, 50, 70 is supported by the support, and for automatically actuating the scan engine upon such detection.

In the FIG. 3 embodiment, the housing is held in the operator's hand in the hand-held mode of operation, and the support is a bottom wall of the housing that rests on the countertop 16. In the FIG. 4 embodiment, the housing has a handle 68 gripped by the operator's hand in the hand-held mode of operation, and the support is the base 62 on the housing that rests on the countertop 16. In the FIGS. 5A, 5B embodiment, the housing has a handle 54 gripped by the operator's hand in the hand-held mode of operation, and the support is the stand 55 for supporting the housing above the countertop 16 or analogous generally planar support surface. The control 58, 60 preferably includes a control element 60 in the stand and another control element 58 in the housing for detecting the presence and absence of the housing on the stand. The control elements may be magnetic sensors, such as a reed switch or a Hall effect sensor, or optical sensors, mounted in the stand and the housing, or at least one mechanical switch in the stand and the housing. In the FIGS. 3 and 4 embodiments, a mechanical pressure switch may conveniently be positioned at the bottom wall or the base 62 of the housing. When the housing is placed on the countertop, the pressure switch is depressed by the weight of the reader, thereby actuating the scan engine.

In another preferred embodiment, a remote host sends a command signal to configure the configurable controller 72 (see FIG. 2), e.g., the microprocessor, in the scan engine, to automatically actuate the scan engine. Alternatively, the controller may be configured by having the reader read a special configuration symbol to automatically actuate the scan engine.

To save energy, the control is operative for cyclically deactuating the scan engine after automatic actuation of the scan engine. For example, the laser 26 and/or the MEMS component 40 can be turned off for a percentage of the scans. This percentage can be increased as the time increases since the last symbol has been read. By way of a numerical example, the laser may initially operate at a 100% duty cycle for five minutes after a symbol has been successfully read, and be changed to a 50% duty cycle by having the control turn the laser on every other scan after fifteen minutes of non-use, and be changed to a 10% duty cycle by having the control turn the laser on every tenth scan after thirty minutes of non-use, and be turned off completely after sixty minutes of non-use. The MEMS component 40 oscillates at relatively high speeds, such as five hundred scan per second, and, hence, even a 10% duty cycle will produce a relatively responsive reader since the laser will be turned on for fifty scans per second.

Another way to save energy is to have the control cyclically deactuate the scan engine at opposite ends of each scan line after automatic actuation. For example, the laser 26 is turned off at the ends of each scan line, thereby consuming less energy. This also makes the scan line shorter and brighter, even as the duty cycle decreases.

If the scan engine has been turned completely off after a prolonged period of non-use, then it may be awakened by pressing a trigger, or by removing the housing from the stand and by replacing it thereon, or by a command signal from a host. Alternatively, an object sensor such as an optical sensor may be mounted on the housing and is operative to wake up the scan engine when the sensor senses that an object has been placed in its field of view.

Hence, according to one feature of this invention, the reader does not utilize a physical trigger subject to breakage as in the prior art to initiate reading when the reader is mounted in a hands-free mode on a generally planar support surface, or a stand, or a fixed support. Also, the reader in the hands-free mode is not energized all the time, thereby saving electrical energy, reducing the generation of waste heat, increasing the lifetime of the scan engine, especially the laser and the MEMS component, as well as increasing the working lifetime of an on-board battery in the case of a wireless reader to power the reader.

It will be understood that each of the elements described above, or two or more together, also may find a useful application in other types of constructions differing from the types described above.

While the invention has been illustrated and described as embodied in a MEMS-based electro-optical reader and method with automatic triggering, it is not intended to be limited to the details shown, since various modifications and structural changes may be made without departing in any way from the spirit of the present invention.

Without further analysis, the foregoing will so fully reveal the gist of the present invention that others can, by applying current knowledge, readily adapt it for various applications without omitting features that, from the standpoint of prior art, fairly constitute essential characteristics of the generic or specific aspects of this invention and, therefore, such adaptations should and are intended to be comprehended within the meaning and range of equivalence of the following claims.

What is claimed as new and desired to be protected by Letters Patent is set forth in the appended claims:

1. A reader for electro-optically reading symbols, comprising:
an actuatable scan engine including an oscillatable microelectromechanical systems (MEMS) scan mirror for scanning a light beam over the symbols for reflection as light of variable intensity therefrom, and for processing signals derived from the variable intensity light into data corresponding to the symbols;
a housing for supporting the scan engine, the housing being supported by an operator in a hand-held mode of operation, and being supported by a support in a hands-free mode of operation; and
a control for detecting when the housing is supported by the support, and for automatically actuating the scan engine upon such detection.

2. The reader of claim 1, wherein the scan engine includes a laser for emitting the light beam as a laser beam, a focusing lens for focusing the laser beam, a drive for oscillating the MEMS mirror, and a photodetector for detecting the variable intensity light to generate the signals to be processed into the data.

3. The reader of claim 1, wherein the housing has a handle gripped by the operator's hand in the hand-held mode of operation.

4. The reader of claim 1, wherein the support is a base on the housing.

5. The reader of claim 1, wherein the support is a stand for supporting the housing above a generally planar support surface.

6. The reader of claim 5, wherein the control includes a control element in the stand and another control element in the housing for detecting the presence and absence of the housing on the stand.

7. The reader of claim 6, wherein the control elements include magnetic sensors in the stand and the housing.

8. The reader of claim 6, wherein the control elements include optical sensors in the stand and the housing.

9. The reader of claim 6, wherein the control elements include at least one mechanical switch in the stand and the housing.

10. The reader of claim 1, wherein the control includes a configurable controller in the scan engine, and wherein the controller is configured by a remote host to automatically actuate the scan engine.

11. The reader of claim 1, wherein the control includes a configurable controller in the scan engine, and wherein the controller is configured by having the reader read a configuration symbol to automatically actuate the scan engine.

12. The reader of claim 1, wherein the control is operative for cyclically deactuating the scan engine after automatic actuation of the scan engine.

13. The reader of claim 12, wherein the MEMS scan mirror is operative for scanning the light beam in scan lines over the symbols, and wherein the control is operative for cyclically deactuating the scan engine at opposite ends of each scan line after automatic actuation of the scan engine.

14. A method of electro-optically reading symbols, comprising the steps of:
oscillating a microelectromechanical systems (MEMS) scan mirror to scan a light beam over the symbols for reflection as light of variable intensity therefrom, and processing signals derived from the variable intensity light into data corresponding to the symbols;
mounting in a housing an actuatable scan engine in which the oscillating and processing steps are performed when actuated;
supporting the housing by an operator in a hand-held mode of operation;
supporting the housing by a support in a hands-free mode of operation; and
detecting when the housing is supported by the support, and automatically actuating the scan engine upon such detection.

15. The method of claim 14, and the steps of emitting the light beam as a laser beam, focusing the laser beam, oscillating the MEMS mirror, and detecting the variable intensity light to generate the signals to be processed into the data.

16. The method of claim 14, and the step of gripping the housing with a handle by the operator's hand in the hand-held mode of operation.

17. The method of claim 14, wherein the step of supporting the housing with the support is performed by a base on the housing.

18. The method of claim 14, wherein the step of supporting the housing with the support is performed by a stand for supporting the housing above a generally planar support surface.

19. The method of claim 18, wherein the detecting step is performed by mounting a control element in the stand and by mounting another control element in the housing for detecting the presence and absence of the housing on the stand.

20. The method of claim 19, and the step of configuring the control elements as magnetic sensors in the stand and the housing.

21. The method of claim 19, and the step of configuring the control elements as optical sensors in the stand and the housing.

22. The method of claim 19, and the step of configuring the control elements as at least one mechanical switch in the stand and the housing.

23. The method of claim 14, and the step of configuring a configurable controller in the scan engine by a remote host to automatically actuate the scan engine.

24. The method of claim 14, and the step of configuring a configurable controller in the scan engine by reading a configuration symbol to automatically actuate the scan engine.

25. The method of claim 14, and the step of cyclically deactuating the scan engine after automatic actuation of the scan engine.

26. The method of claim 25, wherein the oscillating step includes scanning the light beam in scan lines over the symbols, and the step of cyclically deactuating the scan engine at opposite ends of each scan line after automatic actuation of the scan engine.

27. A reader for electro-optically reading symbols, comprising:
actuatable means including an oscillatable microelectromechanical systems (MEMS) scan mirror for scanning a light beam over the symbols for reflection as light of variable intensity therefrom, and for processing signals derived from the variable intensity light into data corresponding to the symbols;
means for supporting the actuatable means, the supporting means being supported by an operator in a hand-held mode of operation, and being supported by a support in a hands-free mode of operation; and
means for detecting when the supporting means is supported by the support, and for automatically actuating the actuatable means upon such detection.

28. The reader of claim 27, wherein the detecting means is operative for cyclically deactuating the actuatable means after automatic actuation of the actuatable means.

29. The reader of claim 27, wherein the MEMS scan mirror is operative for scanning the light beam in scan lines over the symbols, and wherein the detecting means is operative for cyclically deactuating the actuatable means at opposite ends of each scan line after automatic actuation of the actuatable means.
